(19) United States
(12) Patent Application Publication
(10) Pub. No.: US 2024/0102914 A1
(43) Pub. Date: Mar. 28, 2024

(54) CONTINUOUS FLOWCELL MONITORING APPARATUSES AND METHODS

(71) Applicant: Kinetic River Corp., Mountain View, CA (US)

(72) Inventors: Giacomo Vacca, Aptos, CA (US); Rick Yarussi, San Francisco, CA (US); Elijah Sassoon Kashi, San Francisco, CA (US)

(21) Appl. No.: 18/546,508

(22) PCT Filed: Feb. 16, 2022
(86) PCT No.: PCT/US22/16670

§ 371 Date: Aug. 15, 2023

Related U.S. Application Data
(60) Provisional application No. 63/150,030, filed on Feb. 16, 2021.

(51) Int. Cl. G01N 15/14; G01N 15/1434

(52) U.S. Cl. CPC G01N 15/1459; G01N 15/1436; G01N 2015/1006

(57) ABSTRACT

This disclosure relates to an external monitoring device for a flow cytometer. The external monitoring device comprises: a housing configured to reversibly attach to a portion of the flow cytometer such that an optical system within the housing is aligned with a monitoring region within a flowcell of the flow cytometer. The optical system is configured to continuously capture and monitor at least a portion of the optical energy emanating from the monitoring region of the flowcell. The optical system comprises at least one sensor configured to: detect the optical energy captured by the optical system, and generate, based on the detected optical energy, an image of the monitoring region. The external monitoring device may further comprise a processor configured to continuously provide the image to an electronic device, for example a display or a computing device.

### CROSS-REFERENCE TO RELATED APPLICATIONS

This application claims the priority benefit of U.S. Provisional Patent Application Ser. No. 65/150,030, filed on Feb. 16, 2021, and entitled “FLOWCELL MONITORING MODULE,” the contents of which are herein incorporated by reference in their entirety.

### TECHNICAL FIELD

This disclosure pertains to the fields of Particle Analysis, Cell Analysis, Microbiology, and Water Quality Monitoring. In particular, embodiments disclosed herein are capable of enabling improved operation and performance in flow cytometry.

### BACKGROUND

Flow cytometers are ubiquitous laboratory analyzers used for rapid assays of particles (such as human cells, mammalian and non-mammalian animal cells, plant cells, algal cells, bacteria, pollen, nanoparticles, tumor spheroids, and more). Flow cytometers work by flowing particles in liquid suspensions at high speed, substantially one at a time, through one or more light beams, and collecting and analyzing the resulting emitted optical energy (typically a combination of scattered and fluorescent light) to detect the passage of, identify, and characterize the flowing particles.

Proper operation of a flow cytometer is often dependent on accurate and precise alignment of the one or more laser beams with the flowing sample, and on the dimensions and stability of the hydrodynamically focused sample stream (also known as the core stream) within the co-flowing sheath fluid. It is often the case that issues with laser beam alignment, core stream stability, trapped air bubbles, debris, or clogging in the flowcell are not detected right away, generating inaccurate results for some time before degradation of the flow cytometer performance is noticed and corrected. Even when such a performance issue is noticed, it is often not straightforward to triage whether the culprit is in the optics, the fluidics, or elsewhere. In flow cytometers it is therefore often desirable to afford manufacturing and production technicians, quality control engineers, end users, operators, researchers, service engineers, and others a magnified view of the region of the flow cytometer flowcell where a particle-containing sample is typically directed to be interrogated by the one or more light beams.

Direct inspection of this region with the unaided human eye is neither particularly helpful (since the length scales involved are microscopic and not resolvable in sufficient detail without optical magnification) nor advisable (since the use of powerful lasers in a flow cytometer can give rise to bright spots of scattered or reflected light that could cause damage to the unprotected eye). The use of a traditional optical microscope (i.e., one comprising, e.g., an objective lens and a tube lens, meant to be used by directing the magnified image through an eyepiece to the unprotected eye) could provide sufficient optical resolution, but it is unadvisable for the same reasons that direct eye inspection is unadvisable (in fact, more unadvisable, because a conventional microscope typically collects more light from the region of interest than the unaided eye would, and concentrates this light for delivery to the unprotected eye, creating an even greater hazard for eye damage). The use of a digital microscope (e.g., one comprising an optical magnification stage and a detection sensor) could provide sufficient optical resolution without exposing the user to eye damage hazard, but optical microscopes (whether digital or analog) are generally designed to provide a greater optical resolution than flowcell inspection and monitoring would require, adding unnecessary cost. In addition, optical microscopes with the desirable resolution and field of view tend to have relatively short working distances, designed for inspection of microscope slides, rather than a flowcell mounted inside a working flow cytometer, the access to which is generally limited and physically constrained. In addition, optical microscopes can be bulky instruments, ill-suited for attachment to a flow cytometer without requiring extensive modifications.

### SUMMARY

The present disclosure provides a module for continuous monitoring of a flow cytometer flowcell. One aspect of the present disclosure is directed to an external monitoring device for a flow cytometer. In some embodiments, the external monitoring device comprises a housing configured to reversibly attach to a portion of the flow cytometer such that an optical system supported by or attached to the housing is aligned with a monitoring region within a flowcell of the flow cytometer. In some embodiments, the optical system is configured to continuously capture and monitor at least a portion of the optical energy emanating from the monitoring region of the flowcell. In some embodiments, the optical system comprises at least one sensor configured to: detect the optical energy captured by the optical system, and/or generate, based on the detected optical energy, an image of the monitoring region. An external flow cytometry monitoring device may further comprise at least one processor configured to continuously provide the image to an electronic device.

In any of the preceding embodiments, the image comprises a series of images.

In any of the preceding embodiments, at least a portion of the optical energy emanates from the interaction between at least one light beam from at least one excitation light source and a core stream as the core stream flows through the flowcell during operation of the flow cytometer.

In any of the preceding embodiments, the optical system is configured to detect interactions between the at least one beam from the at least one excitation light source and one or more of: one or more structures in the monitoring region, a particle in in the monitoring region, a core stream in the monitoring region, a sheath fluid in the monitoring region, a dye solution in the monitoring region, and a sample in the monitoring region. In any of the preceding embodiments, the optical energy comprises one or more of: reflection, scatter, fluorescence, phosphorescence, and luminescence. In any of the preceding embodiments, the at least one sensor is further configured to: detect the occurrence of one or more anomalies in the optical energy emanating from the monitoring region; and cause the at least one processor to generate indications about the one or more anomalies. In any of the preceding embodiments, the one or more anomalies comprises a misalignment of the core stream and the at least one light beam from the at least one excitation light source. In any of the preceding embodiments, the at least one processor is further configured to send the indications to the electronic device.

In any of the preceding embodiments, the optical system comprises: a first lens within a first distance of an object plane of the monitoring region; and a second lens within a second distance of the at least one sensor. In any of the preceding embodiments, the first distance is substantially equal to a focal length of the first lens. In any of the preceding embodiments, the focal length of the first lens is between about 10 mm and about 100 mm. In any of the preceding embodiments, the second distance between the second lens and the at least one sensor is substantially equal to a focal length of the second lens. In any of the preceding embodiments, the focal length of the second lens is between about 50 mm and about 500 mm. In any of the preceding embodiments, a focal ratio between the second lens and the first lens is between about 1 and about 20.

In any of the preceding embodiments, one or both of: the first lens and the second lens are linearly translatable along the first optical path and the second optical path, respectively.

In any of the preceding embodiments, the optical system further comprises an aperture between the first lens and the second lens.

In any of the preceding embodiments, the optical further comprises a first fold mirror positioned between the first lens and a first side of the second lens. In any of the preceding embodiments, the first lens is positioned in a first optical path and the second lens is positioned in a second optical path. In any of the preceding embodiments, the first optical path is substantially orthogonal to the second optical path. In any of the preceding embodiments, the first fold mirror is adjustable about one or of: a pitch axis and a yaw axis. In any of the preceding embodiments, the first fold mirror is translatable along one or both of: the first optical path and the second optical path.

In any of the preceding embodiments, the optical system further comprises a second fold mirror positioned between a second side of the second lens and the at least one sensor, the at least one sensor being placed at a termination of a third optical path.

In any of the preceding embodiments, the optical system further comprises an aperture between the first lens and the second fold mirror.

In any of the preceding embodiments, the optical system further comprises at least one removable filter positioned between the object plane and the at least one image sensor. In any of the preceding embodiments, the removable filter receives the optical energy emanating from the monitoring region of the flowcell, selectively blocks a first spectral portion of the optical energy, and selectively transmits a second spectral portion of the optical energy toward the at least one image sensor.

In any of the preceding embodiments, the electronic device comprises at least one of: a display device or a storage device.

Another aspect of the present disclosure is directed to an external monitoring device for a flow cytometer. In some embodiments, the external monitoring device comprises a housing configured to reversibly attach to a flowcell defining: a monitoring region within the flow cytometer and an opening positioned for access to the monitoring region. In some embodiments, the housing is configured to support or attach to an optical system configured to continuously capture and monitor optical energy emanating from the flowcell. In any of the preceding embodiments, the optical system further comprises at least one sensor configured to: detect the optical energy captured by the optical system and generate, based on the detected optical energy, an image of the monitoring region. In any of the preceding embodiments, the external monitoring device further comprises at least one processor configured to continuously provide the image to an electronic device.

Another aspect of the present disclosure is directed to a continuous flowcell monitoring device comprising a housing with a connector to enable removable attachment of the flowcell monitoring device to a flowcell defining: a monitoring region of a flow cytometer and an opening positioned for access to the monitoring region. In any of the preceding embodiments, the housing is configured to support or attach to an optical system comprising: at least one image sensor, a first lens positioned to: receive optical energy emanating from the monitoring region of the flowcell and collimate the optical energy in a direction of a first optical path substantially orthogonal to an object plane in the monitoring region, and a second lens positioned to: receive the collimated optical energy from the first lens and converge the optical energy towards the at least one sensor.

In any of the preceding embodiments, the optical system further comprises a first fold mirror positioned to receive optical energy as output from the first lens and reflect the optical energy in a direction of a second optical path substantially orthogonal to the first optical path. In any of the preceding embodiments, the first lens is positioned at a first distance from the object plane, the first distance being substantially equal to a focal length of the first lens. In any of the preceding embodiments, the focal length of the first lens is between about 10 mm and about 100 mm. In any of the preceding embodiments, the second lens is positioned at a second distance from the at least one sensor, the second distance being substantially equal to a focal length of the second lens. In any of the preceding embodiments, the focal length of the second lens is between about 50 mm and about 500 mm.

In any of the preceding embodiments, the optical system further comprises a second fold mirror positioned to receive the converging optical energy as output from the second lens and reflect the converging optical energy in a direction of a third optical path and toward the at least one image sensor, the third optical path being substantially parallel to the first optical path. In any of the preceding embodiments, the optical system further comprises at least one removable filter positioned between the object plane and the at least one image sensor. In any of the preceding embodiments, the removable filter receives the optical energy emanating from the monitoring region of the flowcell, selectively blocks a first spectral portion of the optical energy, and selectively transmits a second spectral portion of the optical energy toward the at least one image sensor. In any of the preceding embodiments, the first fold mirror is positioned at an angle of about 30 degrees to about 60 degrees from the first optical path, and the second fold mirror is positioned at an angle of about 30 degrees to about 60 degrees from the second optical path.

Another aspect of the present disclosure is an external monitoring device for a flow cytometer, the external monitoring device comprising a housing configured to reversibly attach to a portion of the flow cytometer such that an optical system supported by or attached to the housing is aligned with a monitoring region within a flowcell of the flow cytometer. In any of the preceding embodiments, the optical system is configured to continuously monitor a core stream flowing through the monitoring region of the flowcell, the monitoring comprising one or more of: monitoring flow stability of the core stream, monitoring dimensions of the core stream, and monitoring alignment of the core stream with at least one light beam from at least one excitation light source. In any of the preceding embodiments, the at least one light beam from the at least one excitation light source interacts with the core stream as the core stream flows through the monitoring region during operation of the flow cytometer and generates optical energy. In any of the preceding embodiments, at least a portion of the optical energy is captured by the optical system.

In any of the preceding embodiments, the optical system comprises at least one sensor configured to: detect the optical energy captured by the optical system, and generate, based on the detected optical energy, an image of the monitoring region.

In any of the preceding embodiments, an external monitoring device further comprises at least one processor configured to continuously provide the image to an electronic device. In any of the preceding embodiments, the image comprises a series of images. In any of the preceding embodiments, the optical system is further configured to detect interactions between the at least one light beam from at least one excitation light source and one or more of: one or more structures in the monitoring region, a particle in in the monitoring region, a core stream in the monitoring region, a sheath fluid in the monitoring region, a dye solution in the monitoring region, and a sample in the monitoring region.

In any of the preceding embodiments, the optical energy comprises one or more of: reflection, scatter, fluorescence, phosphorescence, and luminescence.

In any of the preceding embodiments, the at least one sensor is further configured to: detect the occurrence of one or more anomalies in the optical energy emanating from the monitoring region; and cause the at least one processor to generate indications about the one or more anomalies. In any of the preceding embodiments, the one or more anomalies comprises a misalignment of the core stream and the at least one light beam from the at least one excitation light source. In any of the preceding embodiments, the at least one processor is further configured to send the indications to the electronic device.

In any of the preceding embodiments, the optical system further comprises: a first lens within a first distance of an object plane of the monitoring region; and a second lens within a second distance of the at least one sensor. In any of the preceding embodiments, the first distance is substantially equal to a focal length of the first lens. In any of the preceding embodiments, the focal length of the first lens is between about 10 mm and about 100 mm. In any of the preceding embodiments, the second distance between the second lens and the at least one sensor is substantially equal to a focal length of the second lens. In any of the preceding embodiments, the focal length of the second lens is between about 50 mm and about 500 mm. In any of the preceding embodiments, a focal ratio between the second lens and the first lens is between about 1 and about 20. In any of the preceding embodiments, one or both of: the first lens and the second lens are linearly translatable along the first optical path and the second optical path, respectively.

In any of the preceding embodiments, the optical system further comprises a first fold mirror positioned between the first lens and a first side of the second lens. In any of the preceding embodiments, the first lens is positioned in a first optical path and the second lens is positioned in a second optical path. In any of the preceding embodiments, the first optical path is substantially orthogonal to the second optical path. In any of the preceding embodiments, the first fold mirror is adjustable about one or both of: a pitch axis and a yaw axis. In any of the preceding embodiments, the first fold mirror is translatable along one or both of: the first optical path and the second optical path.

In any of the preceding embodiments, the optical system further comprises a second fold mirror positioned between a second side of the second lens and the at least one sensor, the at least one sensor being placed at a termination of a third optical path.

In any of the preceding embodiments, the optical system further comprises an aperture between the first lens and the second fold mirror. In any of the preceding embodiments, the optical system further comprises at least one removable filter positioned between the object plane and the at least one image sensor. In any of the preceding embodiments, the removable filter receives the optical energy emanating from the monitoring region of the flowcell, selectively blocks a first spectral portion of the optical energy, and selectively transmits a second spectral portion of the optical energy toward the at least one image sensor.

Another aspect of the present disclosure is directed to a continuous flowcell monitoring device comprising: a housing with a connector to enable attachment of the flowcell monitoring device to a flowcell defining: a monitoring region of a flow cytometer and an opening positioned for access to the monitoring region. In any of the preceding embodiments, the housing supports or attaches to an optical system comprising: at least one image sensor, a first lens positioned to: receive optical energy passing through the monitoring region of the flowcell and substantially collimate the optical energy in a direction of a first optical path substantially orthogonal to an object plane in the monitoring region, and a second lens positioned to: receive the substantially collimated optical energy from the first lens and substantially focus the substantially collimated optical energy towards the at least one sensor.

In any of the preceding embodiments, the connector comprises one or more of: a cage plate, a lens tube coupler, a lens tube, a lens adapter, or a lens mount. In any of the preceding embodiments, the connector further comprises at least one set of supporting cage rods. In any of the preceding embodiments, the attachment comprises reversible physical attachment.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 is a schematic illustration of an apparatus for continuous monitoring of a flow cytometer flowcell in accordance with some embodiments.

FIG. 2 is a schematic illustration of an apparatus for continuous monitoring of a flow cytometer flowcell with a spectral filter in accordance with some embodiments.

FIG. 3 is a schematic illustration of an apparatus for continuous monitoring of a flow cytometer flowcell with a spectral filter in accordance with some embodiments.

FIG. 4 is a schematic illustration of an apparatus for continuous monitoring of a flow cytometer flowcell with one aperture in accordance with some embodiments.

FIG. 5 is a schematic illustration of an apparatus for continuous monitoring of a flow cytometer flowcell with one aperture in accordance with some embodiments.

FIG. 6 is a schematic illustration of an apparatus for continuous monitoring of a flow cytometer flowcell with the first lens being translatable along the optical axis in accordance with some embodiments.

FIG. 7 is a schematic illustration of an apparatus for continuous monitoring of a flow cytometer flowcell with the second lens being translatable along the optical axis in accordance with some embodiments.

FIG. 8 is a schematic illustration of an apparatus for continuous monitoring of a flow cytometer flowcell with the image sensor being translatable along the optical axis in accordance with some embodiments.

FIG. 9 is a schematic illustration of an apparatus for continuous monitoring of a flow cytometer flowcell with one folding mirror in accordance with some embodiments.

FIG. 10 is a schematic illustration of an apparatus for continuous monitoring of a flow cytometer flowcell with two folding mirrors in accordance with some embodiments.

FIG. 11 is a schematic illustration of an apparatus for continuous monitoring of a flow cytometer flowcell with two folding mirrors, the first folding mirror being translatable along the optical axis and adjustable in pitch and yaw angles in accordance with some embodiments.

FIG. 12 is a schematic illustration of an apparatus for continuous monitoring of a flow cytometer flowcell with two off-axis parabolic focusing mirrors in accordance with some embodiments.

FIG. 13 is a schematic illustration of an apparatus for continuous monitoring of a flow cytometer flowcell attached to a flow cytometer.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

The invention is directed to a module for the continuous monitoring of a flow cytometer flowcell for improved assembly, alignment, operation, troubleshooting, and maintenance of the flow cytometer. Some embodiments of the present disclosure provide a solution that affords manufacturers, users, and servicers of flow cytometers a magnified view of the region of the flowcell where one or more laser beams interrogate flowing samples. Some embodiments of the present disclosure further offer a solution with a field of view that includes not only the region of laser interrogation of flowing samples, but also of the surrounding region, including the flowing sheath fluid that typically provides hydrodynamic focusing for the sample, and the inner walls of the flowcell in which both the sample and the sheath fluid typically flow. Some embodiments of the present disclosure provide a solution that is also safe and does not present an increased hazard of eye damage to its users. Some embodiments of the present disclosure provide a solution that is also compact, so as to fit relatively easily within an existing instrument enclosure with minimal modifications. Some embodiments of the present disclosure provide a solution that is further relatively easily fine-tunable by its users. Some embodiments of the present disclosure provide a solution that further offers the ability to monitor the flow cytometer flowcell continuously. Some embodiments of the present disclosure provide a solution that is also retrofittable to augment the capabilities and extend the usable life of existing, installed flow cytometers. Some embodiments of the present disclosure provide a solution that can further be implemented as a removable module for those users who prefer or require it, rather than being designed in as a permanently, originally installed portion of the flow cytometer. Some embodiments of the present disclosure provide a solution that is also relatively inexpensive, conveying sufficient information about the region being monitored for the intended purposes of alignment, stability verification, and troubleshooting at the lowest possible cost.

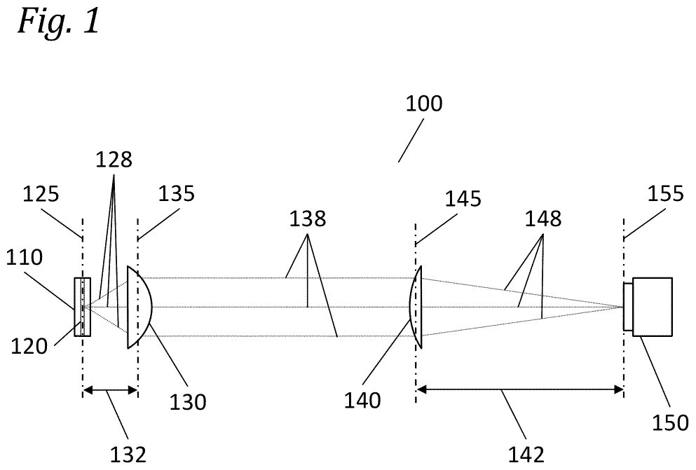

FIG. 1 illustrates schematically a cross-section of a continuous flowcell monitoring module 100 of some embodiments of the present disclosure. Flowcell 110 of a flow cytometer comprises flow microchannel 120, in which a sample flows. The sample may comprise a fluid suspension of one or more particles, such as a microsphere, a cell, a bacterium, a virus, an extracellular vesicle, a pollen grain, a nanoparticle, a nanocrystal, a cell aggregate, or others, as known to those of skill in the art. The sample may alternatively comprise a solution of fluorescent, phosphorescent, luminescent, or absorptive molecules, such as dye molecules, quantum dots, fluorescent proteins, or others, as known to those of skill in the art. The sample may alternatively comprise a cleaning fluid, such as ethanol, isopropyl alcohol, sodium hypochlorite, Hellmanex, Contrad, enzymatic cleaner, or others, as known to those of skill in the art. The sample may be hydrodynamically focused by a co-flowing sheath fluid, such as phosphate buffer solution, distilled water, deionized water, or others, as known to those of skill in the art. The hydrodynamically focused sample may flow in a relatively narrow core stream surrounded by the sheath fluid in the flowcell microchannel. The core stream may generally flow on or near the longitudinal axis of the flowcell microchannel; the plane 125 (perpendicular to the page) running through such longitudinal axis may be referred to as the object plane. Light coming from one or more excitation light sources (not shown), such as a laser, may propagate in a beam substantially perpendicular to the page and may be brought to impinge upon the flowing core stream so as to interrogate the one or more particles or molecules in it. The interactions between the light from the light source(s) and the constituents of the sample may generate elastically scattered light (e.g., without limitation, by Rayleigh scattering or by Mie scattering), reflected light, fluorescence, phosphorescence, luminescence, and/or inelastically scattered light (e.g., without limitation, by Raman scattering, Coherent Anti-Stokes Raman Scattering, and/or Surface-Enhanced Raman Scattering). A portion of this generated optical energy (also referred to here as signal light) may be used by other components of the flow cytometer to provide, e.g., an analysis of the sample. In addition to generating optical energy by interacting with the constituents of the sample, the light from the excitation light source(s) may also generate optical energy by interacting with the outer walls of the flowcell, with the inner walls of the flowcell, with the sheath fluid, and/or with the liquid matrix of the sample. This second type of generated optical energy (also referred to here as background light) is generally unwanted for analysis of the sample.

In some embodiments of the present disclosure, a portion of the signal light, optionally together with a portion of the background light, is collected by a first lens 130. In FIG. 1, such portion is represented by rays 128; a person skilled in the art will readily appreciate that the collected optical energy may comprise a virtually infinite collection of such rays, and that the rays schematically illustrated in FIG. 1 are not limiting. Rays 128 illustrated in FIG. 1 include two marginal rays (the outer rays) and the meridional ray (the center ray, which travels along the optical axis of the module); these rays are commonly used to schematically illustrate propagation of light and image formation in optical systems. Lens 130 is a positive lens, such as a planoconvex lens, a biconvex lens, a best form lens, a positive aspheric lens, a positive achromatic doublet, a positive cemented doublet, a positive air-gap doublet, a positive aspherized achromat, a positive achromatic triplet, a positive compound lens assembly comprising in turn two or more individual discrete elements, a positive metalens, or other lens or lens assembly with an effective positive optical power. In some embodiments, lens 130 is placed such that the distance 132 from object plane 125 to principal plane 135 of lens 130 is substantially equal to lens 130's effective focal length. This collimates the rays of light 128 collected by lens 130 into a bundle of substantially parallel rays 138. A second lens 140 collects collimated light rays 138 and focuses them into converging rays 148 to create on image plane 155 a real image of the object(s) from object plane 125. Lens 140 is a positive lens, such as a planoconvex lens, a biconvex lens, a best form lens, a positive aspheric lens, a positive achromatic doublet, a positive cemented doublet, a positive air-gap doublet, a positive aspherized achromat, a positive achromatic triplet, a positive compound lens assembly comprising in turn two or more individual discrete elements, a positive metalens, or other lens or lens assembly with an effective positive optical power. Image sensor 150 is placed such that the surface of its photosensitive elements lies substantially on image plane 155, with the distance 142 from principal plane 145 of lens 140 to such photosensitive surface substantially equal to an effective focal length of lens 140. The optical image formed onto the image sensor is converted to electronic signals that can be displayed on a screen, monitor, or other display device; stored in RAM, flash memory, hard disk, network storage, cloud storage, or other storage medium; or both displayed and stored.

As known to those of skill in the art, proper selection and orientation of lenses 130 and 140 can have a significant impact on the quality of the formed image. For example, when using two planoconvex lenses as shown in FIG. 1, it is generally desirable to orient the convex side of each lens facing the other; this can act to minimize optical aberrations (e.g., without limitation, spherical aberrations) in the module. Similarly, when using achromatic doublets, it is generally desirable to orient the side with the greater curvature (shorter radius of curvature) toward the collimated portion (where rays 138 propagate), again in an effort to minimize optical aberrations. Lens 130, lens 140, or both, may optionally be provided with antireflection coatings on one or both sides in order to reduce surface reflections. Those of skill in the art will appreciate that many factors enter into proper optical system design, including but not limited to selection of lens configuration, selection of lens materials, selection of lens powers, selection of lenses for overall compensation of optical aberration, lens orientation, precise lens placement, and selection of degrees of freedom for fine tuning, and determination of manufacturing and assembly tolerances. For example, without limitation, in some embodiments of the present disclosure lens 130 may be a cemented achromatic doublet, such as, e.g., Edmund Optics 63-696 (10-mm diameter, 30-mm focal length, N-BK7/N-SF5 doublet, MgF₂ antireflection coated). For example, without limitation, in some embodiments of the present disclosure lens 140 may be an achromatic doublet, such as, e.g., Edmund Optics 32-494 (25-mm diameter, 150-mm focal length, N-BK7/N-SF5 doublet, MgF₂ antireflection coated). In combination, these two lenses, configured in some embodiments as described herein, can produce an image with a transverse optical magnification approximately equal to the ratio of the two focal lengths, or approximately 5. In some embodiments of the present disclosure, in order to optimize the quality of the magnified image, the first doublet lens 130 is mounted with the flatter outer surface facing object plane 125, while the second doublet lens 140 is mounted with the flatter outer surface facing image plane 155, as schematically represented in FIG. 1.

In some embodiments, lenses 130 and 140 are chosen from a vast number of possible choices encompassed by the present disclosure. For example, lens 130 could have a focal length of about 10 mm, about 100 mm, smaller than about 10 mm, larger than about 100 mm, or intermediate between about 10 mm and about 100 mm. For example, lens 140 could have a focal length of about 50 mm, about 500 mm, smaller than about 50 mm, larger than about 500 mm, or intermediate between about 50 mm and about 500 mm. For example, the two lenses 130 and 140 could have a focal length ratio (between the focal length of second lens 140 and that of first lens 130) of 1, 20, less than 1, larger than 20, or intermediate between 1 and 20 or between 1 and 10. For example, either or both lenses could have multilayer antireflection coatings, visible, ultraviolet, near-infrared, or infrared antireflection coatings, antireflection coating spanning other spectral ranges, magnesium fluoride antireflection coatings, or no antireflection coatings at all. For example, either or both of the two lenses could have diameters of about 5 mm, about 50 mm, smaller than about 5 mm, larger than about 50 mm, or intermediate between about 5 mm and about 50 mm. For example, either or both lenses could be achromatic doublets comprising combinations of optical materials such as N-BAF10/N-SF10, N-BAF64/N-SF66, N-BAK1/N-SF8, N-BAK4/N-SF10, N-BK7/N-SF5, N-SF5/N-SK11, N-SSK8/N-SF10, S-BAH11/N-SF10, other combinations, or yet other materials altogether. For example, as described herein, either or both lenses could be a planoconvex lens, a biconvex lens, a best form lens, a positive aspheric lens, a positive achromatic doublet, a positive cemented doublet, a positive air-gap doublet, a positive aspherized achromat, a positive achromatic triplet, a positive compound lens assembly comprising in turn two or more individual discrete elements, a positive metalens, or other lens or lens assembly with an effective positive optical power. For example, the transverse optical magnification of the two-lens system may be from less than about 1 to about 3, from about 3 to about 7, or greater than 7.

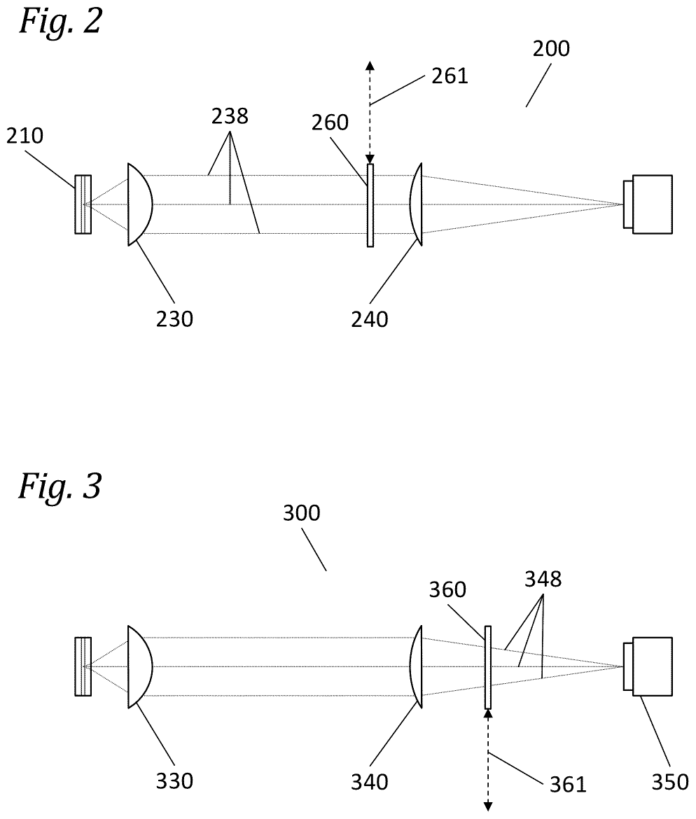

In some embodiments of the present disclosure, the continuous flowcell monitoring module additionally comprises a spectral filter, as illustrated by FIGS. 2 and 3. In FIG. 2, module 200 comprises the components, configuration, and functions of monitoring module 100 from FIG. 1, and in addition comprises spectral filter 260 positioned between lenses 230 and 240. Spectral filter 260 can be used to selectively block portions of the optical energy emanated from flowcell 210 and collected by lens 230. In one embodiment, optical energy generated by elastic scattering or reflection in the flowcell, having the same wavelength as the light in the beam from the corresponding excitation source, is substantially blocked by spectral filter 260, while optical energy generated, e.g., by fluorescence, phosphorescence, luminescence, or inelastic scattering in the flowcell, having a different wavelength than the light in the beam from the corresponding excitation source, is substantially transmitted by spectral filter 260. This allows image(s) of the monitoring region of the flowcell to substantially suppress otherwise potentially overwhelming features resulting from elastically scattered or reflected light, thereby comparatively enhancing features resulting from the interaction between the excitation light beam(s) and, e.g., the sample. For example, without limitation, Thorlabs filter FGL515 may be used as filter 260, providing suppression of elastically scattered light at wavelengths below approximately 515 nm (in particular, of scattered light with wavelengths approximately equal to 488 nm, 405 nm, and/or 355 nm) while allowing transmission of light with wavelengths greater than approximately 515 nm (such as, e.g., fluorescence, phosphorescence, luminescence, or inelastic scattering in the spectral range from approximately 515 nm to approximately 600 nm, in the spectral range from approximately 600 nm to approximately 700 nm, and/or in the spectral range above approximately 700 nm). In one embodiment, filter 260 is removable, e.g., by translation 261 in and out of the path of rays 238, making it possible to switch between an image that contains the scattering features and one where those features are substantially blocked.

In FIG. 3, the components, configuration, and functions of module 300 are the same as in those of module 200 in FIG. 2, except that spectral filter 360 is positioned between lens 340 and image sensor 350, instead of between lens 330 and lens 340. Spectral filter 360 can optionally be inserted into and removed from the path of rays 348, e.g., by translation 361.

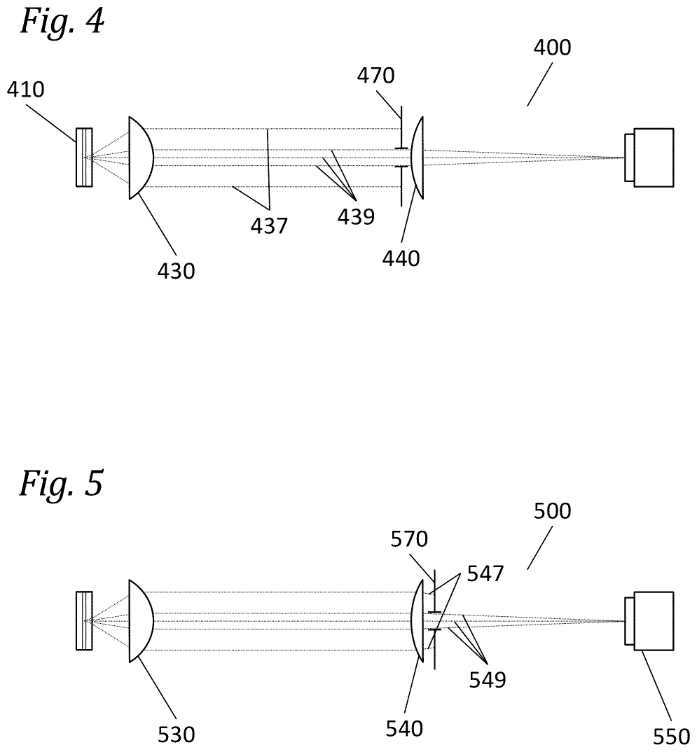

In some embodiments of the present disclosure, the continuous flowcell monitoring module additionally comprises an aperture, as illustrated by FIGS. 4 and 5. In FIG. 4, module 400 comprises the components, configuration, and functions of monitoring module 100 from FIG. 1, and in addition comprises aperture 470 positioned between lenses 430 and 440. Aperture 470 can be used to selectively block portions of the optical energy emanated from flowcell 410 and collected by lens 430. Aperture 470 may be used to selectively block the outer portion 437 of the substantially parallel set of rays propagating between lens 430 and lens 440, and selectively pass through the inner portion 439 of those rays. This allows the module to improve the quality of the image(s) of the monitoring region of the flowcell by blocking some of the outer rays that may generally be more susceptible to, e.g., spherical aberration. In some embodiments, it may be preferable for aperture 470 to be placed in close proximity to lens 440 (e.g., less than 1 mm, less than 2 mm, less than 10 mm, or less than 25 mm from lens 440) in order to have the best impact on image quality. Other placements of aperture 470 are possible, with varying tradeoffs between simplicity of implementation and quality of image formation. In some embodiments, aperture 470 may be between about 1 mm and about 5 mm in diameter, between about 5 mm and about 10 mm in diameter, between about 10 mm and about 20 mm in diameter, less than about 1 mm in diameter, or greater than about 20 mm in diameter. In some embodiments, aperture 470 is optionally adjustable in opening size (i.e., a variable aperture, as is also known in the art as an iris or diaphragm), for example over a range from approximately 1 mm to approximately 20 mm in diameter, allowing a variable tradeoff between, e.g., sharpness of image focus and overall image brightness. A variable aperture allows a user of the module to flexibly adopt a relatively larger aperture size (e.g., without limitation, approximately 10 mm in diameter) for monitoring samples with relatively dim particles and/or with particles in relatively low concentration, and to adjust the aperture size to a relatively smaller value (e.g., without limitation, approximately 5 mm in diameter) for monitoring samples with relatively bright particles and/or with particles in relatively high concentration.

In FIG. 5, the components, configuration, and functions of module 500 are the same as those of module 400 in FIG. 4, except that aperture 570 is positioned between lens 540 and image sensor 550, instead of between lens 530 and lens 540, blocking outer rays 547 and passing through inner rays 549. Aperture 570 is optionally adjustable in opening size. In some embodiments, it may be preferable for aperture 570 to be placed in close proximity to lens 540 (e.g., less than about 1 mm, less than about 2 mm, less than about 10 mm, or less than about 25 mm from lens 540) in order to have the best impact on image quality. Other placements of aperture 570 are possible, with varying tradeoffs between simplicity of implementation and quality of image formation. In some embodiments, aperture 570 may be between about 1 mm and about 5 mm in diameter, between about 5 mm and about 10 mm in diameter, between about 10 mm and about 20 mm in diameter, less than about 1 mm in diameter, or greater than about 20 mm in diameter. In some embodiments, aperture 570 is optionally adjustable in opening size (i.e., a variable aperture, as is also known in the art as an iris or diaphragm), allowing a variable tradeoff between, e.g., sharpness of image focus and overall image brightness, as described herein in reference to FIG. 4.

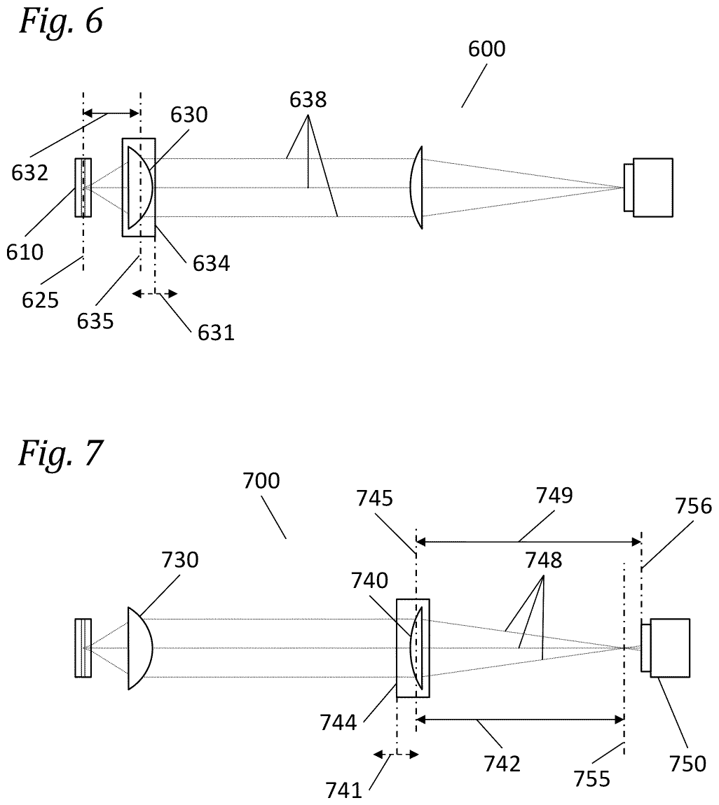

In some embodiments of the present disclosure, the continuous flowcell monitoring module additionally comprises mounts for adjustment of the position of one or more module component, as illustrated by FIGS. 6, 7, and 8. In FIG. 6, module 600 comprises the components, configuration, and functions of monitoring module 100 from FIG. 1, and in addition comprises mount 634 (e.g., without limitation, Thorlabs dual flexure cage plate CP02F, optionally in combination with a lens tube coupler, a lens tube, and a lens adapter; and in combination with a set of two to four supporting cage rods such as, e.g., without limitation, Thorlabs ER1) for lens 630 that allows linear translation 631 of lens 630 substantially along the optical axis of the module. Such translation provides for the distance 632 between principal plane 635 of lens 630 and object plane 625 in flowcell 610 to be varied to optimize the quality of the resulting image, e.g., by optimizing collimation of rays 638.

In FIG. 7, module 700 comprises the same components, configuration, and functions of monitoring module 600 from FIG. 6, except that instead of a mount for lens 730 it comprises mount 744 (e.g., without limitation, Thorlabs cage plate CP33T in combination with a set of two to four supporting cage rods such as, e.g., without limitation, Thorlabs ER6) for lens 740 that allows linear translation 741 of lens 740 substantially along the optical axis of the module. Such translation provides for the distance 749 between principal plane 745 of lens 740 and the surface plane 756 of the photosensitive elements of image sensor 750 to be varied to optimize the quality of the resulting image, e.g., by optimizing focusing of rays 748 onto image sensor 750 (e.g., by minimizing the difference between the position of image plane 755 and the surface of photosensitive elements of image sensor 750, or by minimizing the difference between distance 749—the distance from principal plane 745 of lens 740 to the photosensitive surface 756 of image sensor 750—and distance 742—the distance from principal plane 745 of lens 740 to image plane 755; in FIG. 7 such difference is pedagogically illustrated as appreciable, while in a desirable implementation of the present disclosure such difference would be minimized, e.g., so as to being substantially unappreciable).

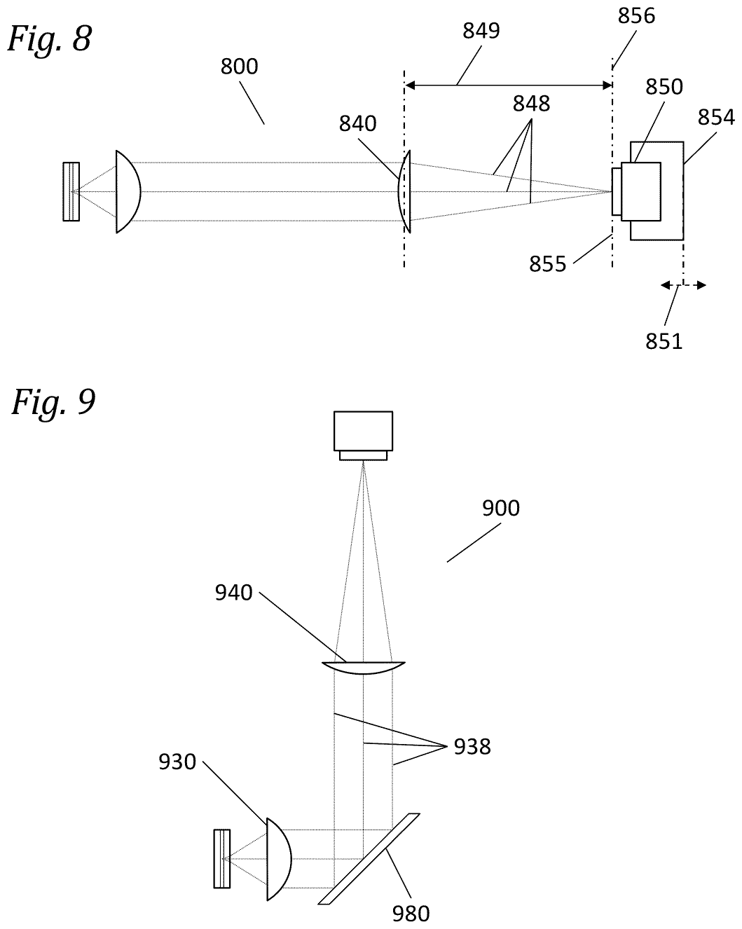

In FIG. 8, module 800 comprises the same components, configuration, and functions of monitoring module 700 from FIG. 7, except that instead of a mount for lens 840 it comprises mount 854 (e.g., without limitation, a custom dovetail sliding assembly with an integrated sensor clamping fixture on the moving shuttle and a fixing fastener on the stationary rail) that allows linear translation 851 of image sensor 850 substantially along the optical axis of the module. Such translation provides for the distance 849 between lens 840 and the photosensitive surface plane 856 of image sensor 850 (pedagogically shown here coinciding with image plane 855, as may generally be desirable) to be varied to optimize the quality of the resulting image, e.g., by optimizing focusing of rays 848 onto image sensor 850. In some embodiments, two or more of the variable adjustment mounts described herein in relation to FIGS. 6, 7, and 8 may be combined to provide even greater functionality and capability for optimization.

In some embodiments of the present disclosure, the continuous flowcell monitoring module additionally comprises one or more fold mirrors for rendering the module implementation more compact, as illustrated by FIGS. 9, 10, and 11. In FIG. 9, module 900 comprises the components, configuration, and functions of monitoring module 100 from FIG. 1, and in addition comprises a fold mirror 980 placed between lenses 930 and 940 to bend rays 938 and fold the optical configuration of the module. While in FIG. 9 an example is illustrated with mirror 980 at approximately 45 degrees from the direction of the optical path (i.e., the direction of the meridional, or center, ray) from lens 930 to mirror 980, with rays 938 therefore undergoing an approximately 90-degree folding turn, a virtually limitless number of folding angles are contemplated by the present disclosure. Depending on the physical constraints of the flow cytometer to which the monitoring module is to attach to, it may be desirable for the folding turn in rays 938 to be less than about 90 degrees (e.g., from about 90 degrees to about 60 degrees, from about 60 degrees to about 30 degrees, or less than about 30 degrees) or greater than about 90 degrees (e.g., from about 90 degrees to about 120 degrees, from about 120 degrees to about 150 degrees, or from about 150 degrees to about 180 degrees). In some embodiments, a 90-degree turn may be desirable to accommodate a standard commercial 45-degree mount for fold mirror 980. In some embodiments, other types of commercial mirror mounts may be used, or a custom designed and manufactured mount may be used. In some embodiments, mirror 980 may comprise a polished substrate (including, without limitation, glass, quartz, ceramic, or silicon) and a front-surface coating (including, without limitation, unprotected aluminum, protected aluminum, enhanced aluminum, unprotected silver, protected silver, enhanced silver, unprotected gold, protected gold, enhanced gold, a broadband dielectric coating, an interference thin-film filter, a dichroic beamsplitting coating, or a combination of these). In some embodiments, the type of coating for mirror 980 may be chosen to reflect a substantial portion of the optical energy emanating from the flowcell, such as the visible optical range (approximately 400 nm to 750 nm), the near infrared range (approximately 750 nm to 1400 nm), wavelengths longer than 1400 nm, the near ultraviolet range (approximately 300 nm to 400 nm), the middle ultraviolet (approximately 200 nm to 300 nm), wavelengths shorter than 200 nm, or portions, combinations, or combinations of portions of these.

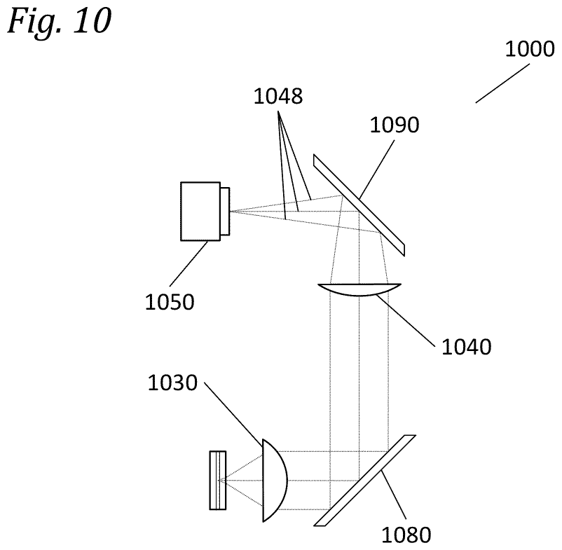

In FIG. 10, module 1000 comprises the components, configuration, and functions of monitoring module 900 from FIG. 9, and in addition comprises a fold mirror 1090 placed between lens 1040 and image sensor 1050 to bend rays 1048 and further fold the optical configuration of the module. While in FIG. 10 an example is illustrated with mirror 1090 at approximately 45 degrees from the direction of the optical path (i.e., the direction of the meridional, or center, ray) between lens 1040 and mirror 1090, with rays 1048 therefore undergoing an approximately 90-degree folding turn, a virtually limitless number of folding angles are contemplated by the present disclosure. Depending on the physical constraints of the flow cytometer to which the monitoring module is to attach to, it may be desirable for the folding turn in rays 1048 to be less than about 90 degrees (e.g., from about 90 degrees to about 60 degrees, from about 60 degrees to 30 about degrees, or less than about 30 degrees) or greater than about 90 degrees (e.g., from about 90 degrees to about 120 degrees, from about 120 degrees to about 150 degrees, or from about 150 degrees to nearly about 180 degrees). In some embodiments, a 90-degree turn may be desirable to accommodate a standard commercial 45-degree mount for fold mirror 1090. In some embodiments, other types of commercial mirror mounts may be used, or a custom designed and manufactured mount may be used. In some embodiments, mirror 1090 may comprise a polished substrate (including, without limitation, glass, quartz, ceramic, or silicon) and a front-surface coating (including, without limitation, unprotected aluminum, protected aluminum, enhanced aluminum, unprotected silver, protected silver, enhanced silver, unprotected gold, protected gold, enhanced gold, a broadband dielectric coating, an interference thin-film filter, a dichroic beamsplitting coating, or a combination of these). In some embodiments, the type of coating for mirror 1090 may be chosen to reflect a substantial portion of the optical energy emanating from the flowcell, such as the visible optical range (approximately 400 nm to 750 nm), the near infrared range (approximately 750 nm to 1400 nm), wavelengths longer than 1400 nm, the near ultraviolet range (approximately 300 nm to 400 nm), the middle ultraviolet (approximately 200 nm to 300 nm), wavelengths shorter than 200 nm, or portions, combinations, or combinations of portions of these.

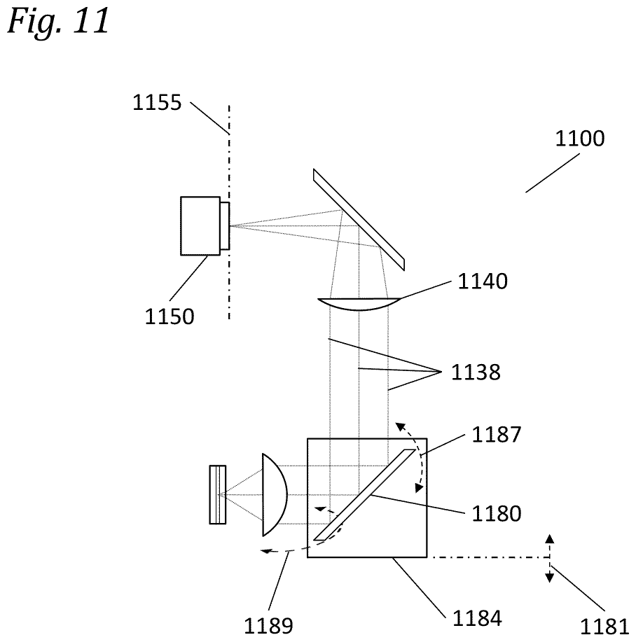

In some embodiments of the present disclosure, the continuous flowcell monitoring module additionally comprises one or more mounts for angular adjustment of one or more of the fold mirrors, as illustrated by FIG. 11. In FIG. 11, module 1100 comprises the components, configuration, and functions of monitoring module 1000 from FIG. 10, and in addition comprises mount 1184 (e.g., without limitation, Thorlabs mount C45P in combination with a set of two to four supporting cage rods such as, e.g., Thorlabs ER6) that allows angular adjustments 1187 and 1189 of fold mirror 1180. Such angular adjustments are generally referred to in the art as, respectively, pitch 1187 (in the plane of the page) and yaw 1189 (out of the plane of the page) angle adjustments, or tip and tilt angle adjustments. Such adjustments provide for the image of the monitoring region, formed on image sensor 1150, to be translated in two dimensions substantially on image plane 1155; this, in turn, enables the field of view of the continuous flowcell monitoring module 1100 to be fine-tuned in both image plane dimensions (left/right and up/down) so as to center the field of view on the region of greatest interest. Such fine tuning may be effected during assembly in manufacturing, during regular maintenance events, or for troubleshooting, or it may be performed by an operator whenever desired to optimize the field of view of the image. In addition to angular adjustments, mount 1184 may allow linear translation 1181 of mirror 1180 along either the incoming optical path direction or (as shown) along the outgoing optical path direction. Such translation allows mirror 1180 to be properly centered onto the incoming optical path, and allows reflected rays 1138 of optical energy to be properly centered onto lens 1140. In some embodiments, two or more of the variable adjustment mounts described herein in relation to FIGS. 6, 7, 8, and 11 may be combined to provide even greater functionality and capability for optimization.

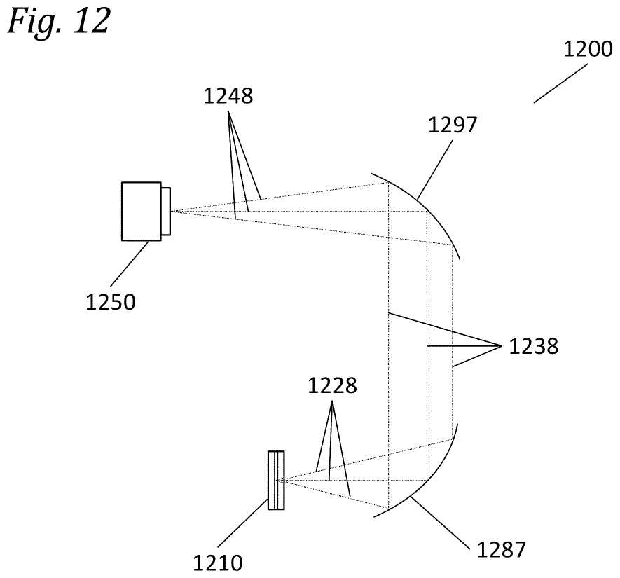

In some embodiments of the present disclosure, the functions of lenses and mirrors in other embodiments described herein are combined. In FIG. 12, module 1200 comprises the components, configuration, and functions of monitoring module 1000 from FIG. 10, except that the functions of lens 1030 and fold mirror 1080 are combined into first off-axis parabolic focusing mirror 1287; and the functions of lens 1040 and fold mirror 1090 are combined into second off-axis parabolic focusing mirror 1297. Diverging optical energy rays 1228 emanating from flowcell 1210 are collected by first mirror 1287 and simultaneously collimated into rays 1238; second parabolic mirror 1297 refocuses rays 1238 into rays 1248 onto the photosensitive surface of image sensor 1250. Like lenses, focusing mirrors can be specified and/or selected to have a desired focal length. Mirror 1287, for example, without limitation, may have a focal length of between about 10 mm and about 100 mm, and mirror 1297 may, without limitation, have a focal length of between about 50 mm and about 500 mm. In combination, focusing mirrors 1287 and 1297, configured in some embodiments as described herein, may produce an image with a transverse optical magnification approximately equal to the ratio of the focal length of the second mirror to the focal length of the first mirror; for example, without limitation, a magnification from less than about 1 to about 3, from about 3 to about 7, or greater than 7. In some embodiments, only lens 1030 and fold mirror 1080 from FIG. 10 are combined into focusing mirror 1287, while lens 1040 and optional fold mirror 1090 are left unchanged. In some embodiments, only lens 1040 and fold mirror 1090 from FIG. 10 are combined into focusing mirror 1297, while lens 1030 and optional fold mirror 1080 are left unchanged.

In some embodiments, the use of reflective parabolic mirrors 1287 and 1297 may be desirable in order to collect optical energy (e.g., near, middle, and deep UV) that may be absorbed to an undesirable degree by lens materials such as borosilicate glass or fused silica. Translational adjustments to lenses as described in reference to other embodiments herein may also be applied to mirrors 1287 and/or 1297; and angular adjustments to a fold mirror as described in reference to other embodiments herein may also be applied to mirrors 1287 and/or 1297. Module 1200 may likewise comprise, as described in reference to other embodiments herein, one or more spectral filters and/or an aperture, fixed or variable.

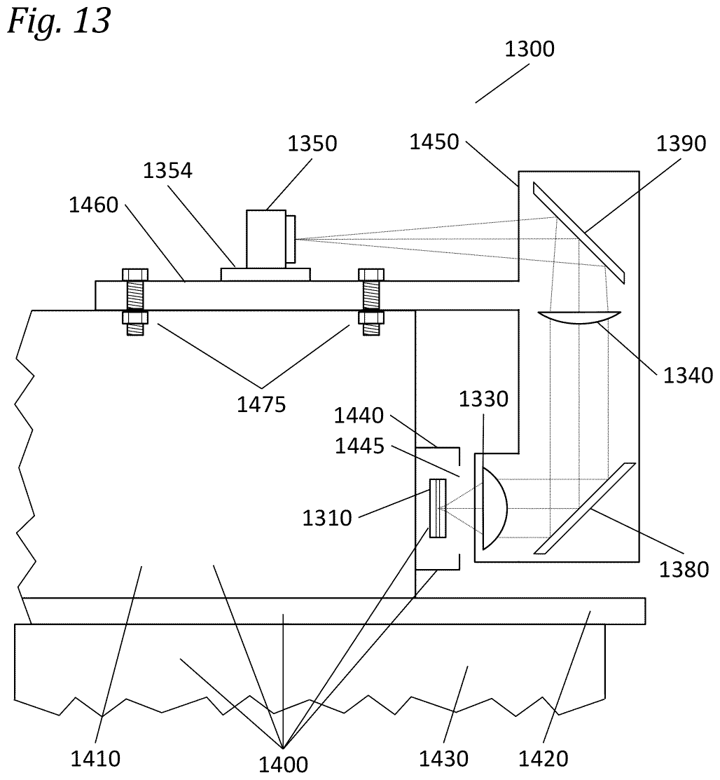

In some embodiments of the present disclosure, the continuous flowcell monitoring module is mounted onto a flow cytometer, as illustrated in FIG. 13. In FIG. 13, the components, configuration, and functions of monitoring module 1300 are the same as those of monitoring module 1000 from FIG. 10, and in addition FIG. 13 schematically illustrates an embodiment of attachment of module 1300 to a flow cytometer. A portion of a flow cytometer 1400 is shown, including a portion of an enclosure 1410 (e.g., without limitation, an enclosure of an optical detection module), a portion of a structural plate 1420, a portion of a supporting structure 1430, a flowcell 1310, and a flowcell mount and enclosure 1440. It will be appreciated by those skilled in the art that flow cytometers can take on a wide variety of configurations, and that other shapes and mutual relationships of the flow cytometer components schematically illustrated in FIG. 13 are also encompassed by the present disclosure. Flowcell mount and enclosure 1440 define an opening 1445, through which optical energy emanated from the flowcell can be transmitted. Monitoring module 1300 may comprise a first lens 1330, an optional first fold mirror 1380, a second lens 1340, an optional second mirror 1390, an image sensor 1350, an image sensor mount 1354, and module housing 1450, which may in turn comprise rail 1460. In some embodiments, image sensor mount 1354 and rail 1460 may be configured, e.g., without limitation, in a dovetail fashion, so that mount 1354 may slide on rail 1460 to achieve longitudinal translation of mount 1354 and image sensor 1350. Image sensor 1350 may be attached onto mount 1354 by means including, without limitation, one or more clamps, one or more straps, one or more bolts, adhesive, pressure fit, or other fastening means as are known in the art. In some embodiments, housing 1450 may be attached onto flow cytometer 1400 by fasteners such as nuts and bolts 1475 (which may fasten onto a permanent portion of enclosure 1410, may alternatively fasten onto a removable portion of enclosure 1410, or may fasten permanently or removably onto another portion of flow cytometer 1400), or it may be attached by means including, without limitation, one or more machine screws, one or more rivets, one or more clamps, adhesive, or other fastening means as are known in the art. In some embodiments, housing 1450 may be fashioned out of a single block of material, which material may be, without limitation, aluminum, plastic, or other machinable solid material. In some embodiments, housing 1450 may be fashioned by additive manufacturing (e.g., 3D printing) formed out of or comprising plastic, UV-curable polymers, or other materials as are known in the art. In some embodiments, housing 1450 may comprise several elements designed to be assembled together, such as a combination of 3D-printed components and machined plastic or metal components (including, e.g., without limitation, cage rods and cage plates as are furnished by various manufacturers known in the art). Module 1300 may additionally comprise elements to provide further support, such as a block to be attached to housing 1450 below or near mirror 1380 and resting or fastened onto support plate 1420. Module 1300 may be permanently installed onto flow cytometer 1400, or it may be reversibly installed, allowing removal of module 1300 for, e.g., without limitation, installation onto a different flow cytometer, factory recalibration, and/or manufacturing upgrades.

As used in the description and claims, the singular form “a”, “an” and “the” include both singular and plural references unless the context clearly dictates otherwise. For example, the term “mount” may include, and is contemplated to include, a plurality of mounts. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 10%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

As used herein, the term “sample” refers to a liquid sample, a fluid sample, a solution comprising, e.g., sample material dissolved into a fluid, a sample suspension comprising, e.g., sample particles, solids, and/or other insoluble matter suspended in a fluid, a sample slurry comprising, e.g., a mixture of different sample particles, solids, and/or other insoluble matter suspended in a fluid, a multiphase material comprising sample solids and fluids, and other compositions or arrangements of matter that can be flowed, either of themselves or as solutions, suspensions, dispersions, slurries, or other configurations.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A monitoring device for a flow cytometer, the monitoring device comprising:
a housing configured to attach to a portion of the flow cytometer such that an optical system coupled to the housing is substantially aligned with a monitoring region within a flowcell of the flow cytometer,
wherein the optical system is configured to continuously capture and monitor at least a portion of optical energy received from the monitoring region of the flowcell, and
wherein the optical system comprises at least one sensor configured to:
detect the optical energy captured by the optical system, and
generate, based on the detected optical energy, an image of the monitoring region; and
at least one processor configured to continuously provide the image to an electronic device.

2. The monitoring device of claim 1, wherein the image comprises a series of images.

3. The monitoring device of claim 1, wherein the at least a portion of optical energy emanates from an interaction between at least one light beam from at least one excitation light source and a sample core stream as the sample core stream flows through the flowcell during operation of the flow cytometer.

4. The monitoring device of claim 1, wherein the optical system is configured to detect interactions between at least one beam from at least one excitation light source and one or more of: one or more structures in the monitoring region, a particle in in the monitoring region, a sample core stream in the monitoring region, a sheath fluid in the monitoring region, a dye solution in the monitoring region, an air bubble in the monitoring region, a cleaning fluid in the monitoring region, and a sample in the monitoring region.

5. The monitoring device of claim 1, wherein the optical energy comprises one or more of: reflection, scatter, fluorescence, phosphorescence, and luminescence.

6. The monitoring device of claim 1, wherein the at least one sensor is further configured to:
detect an occurrence of one or more anomalies in the optical energy emanating from the monitoring region; and
cause the at least one processor to generate indications about the one or more anomalies; and
wherein the at least one processor is further configured to send the indications to the electronic device.

7. The monitoring device of claim 6, wherein the one or more anomalies comprises one or more of: a misalignment of a sample core stream and at least one light beam from at least one excitation light source, debris in the monitoring region, an air bubble in the monitoring region, clogging in the flowcell, and an unstable sample core stream.

8. (canceled)

9. The monitoring device of claim 1, wherein the optical system comprises:
a first lens within a first distance of an object plane of the monitoring region; and
a second lens within a second distance of the at least one sensor; and wherein the optical energy captured by the optical system is substantially collimated between the first lens and the second lens.

10. (canceled)

11. (canceled)

12. (canceled)

13. (canceled)

14. (canceled)

15. (canceled)

16. The monitoring device of claim of claim 9, wherein the optical system further comprises an aperture between the first lens and the second lens.

17. (canceled)

18. (canceled)

19. (canceled)

20. (canceled)

21. (canceled)

22. (canceled)

23. The monitoring device of claim 1, wherein the optical system further comprises at least one removable filter positioned between an object plane and the at least one sensor, wherein the at least one removable filter receives the optical energy emanating from the monitoring region of the flowcell, selectively blocks a first spectral portion of the optical energy, and selectively transmits a second spectral portion of the optical energy toward the at least one sensor.

24. (canceled)

25. (canceled)

26. A continuous flowcell monitoring device comprising:
a housing with a connector to enable attachment of the flowcell monitoring device to a flowcell defining: a monitoring region of a flow cytometer and an opening positioned for access to the monitoring region,
wherein the housing is configured to couple to an optical system comprising:
at least one image sensor,
a first lens positioned to: receive optical energy from the monitoring region of the flowcell and substantially collimate the optical energy, and
a second lens positioned to: receive the substantially collimated optical energy from the first lens and substantially focus the substantially collimated optical energy towards the at least one image sensor.

27. The continuous flowcell monitoring device of claim 26, wherein the attachment comprises reversible physical attachment.

28. The continuous flowcell monitoring device of claim 26, wherein the optical system further comprises an aperture between the first lens and the second lens.

29. (canceled)

30. (canceled)

31. (canceled)

32. (canceled)

33. The continuous flowcell monitoring device of claim 26, wherein the optical system further comprises at least one removable filter positioned between the monitoring region and the at least one image sensor, wherein the at least one removable filter receives the optical energy emanating from the monitoring region of the flowcell, selectively blocks a first spectral portion of the optical energy, and selectively transmits a second spectral portion of the optical energy toward the at least one image sensor.

34. (canceled)

35. A monitoring device for a flow cytometer, the monitoring device comprising:
a housing configured to attach to a portion of the flow cytometer such that an optical system coupled to the housing is substantially aligned with a monitoring region within a flowcell of the flow cytometer,
wherein the optical system is configured to continuously monitor a sample core stream flowing through the monitoring region of the flowcell, the monitoring comprising one or more of: monitoring flow stability of the sample core stream, monitoring dimensions of the sample core stream, and monitoring alignment of the sample core stream with at least one light beam from at least one excitation light source, wherein the at least one light beam from the at least one excitation light source interacts with the sample core stream as the sample core stream flows through the monitoring region during operation of the flow cytometer and generates optical energy, and wherein at least a portion of the optical energy is captured by the optical system;
wherein the optical system comprises at least one sensor configured to:
detect the optical energy captured by the optical system, and
generate, based on the detected optical energy, an image of the monitoring region; and
at least one processor configured to continuously provide the image to an electronic device.

36. The monitoring device of claim 35, wherein the image comprises a series of images.

37. The monitoring device of claim 35, wherein the optical system is further configured to detect interactions between the at least one light beam from the at least one excitation light source and one or more of: one or more structures in the monitoring region, a particle in in the monitoring region, the sample core stream in the monitoring region, a sheath fluid in the monitoring region, a dye solution in the monitoring region, an air bubble in the monitoring region, a cleaning fluid in the monitoring region, and a sample in the monitoring region.

38. The monitoring device of claim 35, wherein the optical energy comprises one or more of: reflection, scatter, fluorescence, phosphorescence, and luminescence.

39. The monitoring device of claim 35, wherein the at least one sensor is further configured to:
detect an occurrence of one or more anomalies in the optical energy emanating from the monitoring region; and
cause the at least one processor to generate indications about the one or more anomalies; and
wherein the at least one processor is further configured to send the indications to the electronic device.

40. The monitoring device of claim 39, wherein the one or more anomalies comprises one or more of: a misalignment of the sample core stream and the at least one light beam from the at least one excitation light source, debris in the monitoring region, an air bubble in the monitoring region, clogging in the flowcell, and an unstable sample core stream.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)
